(19) United States
(12) Patent Application Publication
(10) Pub. No.: US 2024/0336067 A1
(43) Pub. Date: Oct. 10, 2024

(54) BOTTLE

(71) Applicant: CANON KABUSHIKI KAISHA, Tokyo (JP)

(72) Inventor: AKANE HISANAGA, Tokyo (JP)

(21) Appl. No.: 18/624,019

(22) Filed: Apr. 1, 2024

(30) Foreign Application Priority Data
Apr. 6, 2023 (JP) 2023-062321

(51) Int. Cl. B41J 2/175; B65D 1/02; B65D 47/12

(52) U.S. Cl. CPC B41J 2/17509; B65D 1/02; B65D 47/12

(57) ABSTRACT

A bottle for a recording apparatus is used that includes a recording head for discharging liquid and a liquid tank for containing liquid supplied to the recording head. The bottle includes a bottle body for containing the liquid, and a liquid supply portion for connection to a supplied portion included in the liquid tank. The liquid supply portion includes a flow path for passing the liquid from the bottle body to the liquid tank. The liquid supply portion includes, at a distal end thereof away from the bottle body, an outer peripheral surface for connection to an inner peripheral surface of the supplied portion and a port including an opening surrounded by the outer peripheral surface for supplying the liquid to the liquid tank from the flow path. The port has a groove provided therein.

### BACKGROUND OF THE INVENTION

### Field of the Invention

The present invention relates to bottles.

### Description of the Related Art

Some liquid tanks used for liquid discharge apparatuses, such as ink jet recording apparatuses, may be refilled by supplying liquid from separately provided ink container bottles. In such a liquid discharge apparatus, to supply ink to the liquid tank, an ink container bottle is attached to the liquid tank. While the ink container bottle is attached to the liquid tank, the interior of the ink container bottle remains in communication with the interior of the liquid tank via a flow path provided in the ink container bottle. With the ink container bottle attached to the liquid tank, printing liquid, such as ink, can be supplied to the liquid tank from the ink container bottle by pressing the ink container sidewall of the ink container bottle.

In Japanese Patent Application Publication No. 2020-189454, ink is supplied to a liquid tank from an ink container bottle by the so-called chicken-feed method. The ink container bottle has two flow paths for passing liquid and gas to allow gas liquid exchange by passing air through an opening of one of the flow paths and passing ink through an opening of the other flow path. The liquid level of the ink rises due to the flow of ink into the liquid tank, and when the ink reaches the opening through which the ink passes, the passage of air is cut off. As a result, the passage of ink from the ink container bottle to the liquid tank stops.

### SUMMARY OF THE INVENTION

When an ink container bottle is attached to the liquid tank to supply ink to the liquid tank, ink may inadvertently adhere to the opening of the ink container bottle and the surrounding area thereof. In Japanese Patent Application Publication No. 2020-189454, the supply of ink from the ink container bottle to the liquid tank stops when the liquid level of the ink in the liquid tank comes into contact with the opening of the ink container bottle. For this reason, when the ink container bottle is detached from the liquid tank after the supply of ink is stopped from the ink container bottle to the liquid tank, ink is likely to be adhering to the opening of the ink container bottle and the surrounding area thereof. As a result, the ink adhering to the opening and the surrounding area thereof may fall to the surrounding area in droplets (i.e., dripping ink) or trickles to the side surface (i.e., trickling ink) so as to soil the user's hand or the surrounding area.

With the foregoing problem in view, it is an object of the present invention to reduce the contamination of the opening of an ink container bottle for supplying ink to a liquid tank and the surrounding area thereof.

The present invention provides a bottle for use with a recording apparatus comprising a recording head for discharging liquid and a liquid tank for containing liquid supplied to the recording head, the bottle comprising:
a bottle body for containing the liquid; and
a liquid supply portion for connection to a supplied portion included in the liquid tank, the liquid supply portion including a flow path for passing the liquid from the bottle body to the liquid tank,
wherein the liquid supply portion includes, at a distal end thereof away from the bottle body, an outer peripheral surface for connection to an inner peripheral surface of the supplied portion and a port including an opening surrounded by the outer peripheral surface for supplying the liquid to the liquid tank from the flow path, and
wherein the port has a groove provided therein.

The present invention also provides a bottle for use with a recording apparatus comprising a recording head for discharging liquid and a liquid tank for containing liquid supplied to the recording head, the bottle comprising:
a bottle body for containing the liquid; and
a liquid supply portion for connection to a supplied portion included in the liquid tank, the liquid supply portion including a flow path for passing the liquid from the bottle body to the liquid tank,
wherein the liquid supply portion includes, at a distal end thereof away from the bottle body, an outer peripheral surface for connection to an inner peripheral surface of the supplied portion and a port including an opening surrounded by the outer peripheral surface for supplying the liquid to the liquid tank from the flow path, and
wherein the port has a rib provided therein.

According to the present invention, contamination can be reduced of the opening of an ink container bottle for supplying ink to a liquid tank and the surrounding area thereof.

Further features of the present invention will become apparent from the following description of exemplary embodiments with reference to the attached drawings.

### BRIEF DESCRIPTION OF THE DRAWINGS

FIG. 1 is a perspective view of a recording apparatus of an Embodiment 1 of the present invention;

FIG. 2 is a side view of an essential part of the recording apparatus of Embodiment 1;

FIG. 3 shows a perspective view showing how liquid is refilled to the recording apparatus shown in FIG. 1;

FIG. 4 is a component diagram of an ink container bottle of Embodiment 1;

FIGS. 5A and 5B are cross-sectional views of a nozzle body of Embodiment 1;

FIGS. 6A and 6B are cross-sectional views showing how liquid is refilled according to Embodiment 1;

FIGS. 7A to 7D are plan views of grooves of Embodiment 1;

FIGS. 8A to 8F are cross-sectional views of the grooves of Embodiment 1;

FIGS. 9A and 9B are plan views of grooves of an Embodiment 2;

FIGS. 10A and 10B are plan views of grooves of an Embodiment 3;

FIGS. 11A and 11B are plan views of grooves of an Embodiment 4;

FIGS. 12A to 12C are plan views of grooves of an Embodiment 5;

FIGS. 13A to 13C are cross-sectional views of the grooves of Embodiment 5;

FIGS. 14A to 14C are plan views of grooves of an Embodiment 6;

FIGS. 15A to 15E are cross-sectional views of the grooves of Embodiment 6;

FIGS. 16A to 16C are plan views of grooves of an Embodiment 7;

FIGS. 17A to 17D are cross-sectional views of the grooves of Embodiment 7;

FIGS. 18A to 18F are plan views of variations of the grooves of Embodiment 7;

FIGS. 19A to 19F are plan views of grooves of an Embodiment 8;

FIG. 20 is a plan view of a variation of the grooves of Embodiment 8;

FIGS. 21A to 21D are plan views of ribs of an Embodiment 9;

FIGS. 22A to 22D are cross-sectional views of the ribs of Embodiment 9;

FIGS. 23A to 23D are plan views of grooves and ribs of an Embodiment 10;

FIGS. 24A to 24D are cross-sectional views of the grooves and ribs of Embodiment 10;

FIGS. 25A to 25D are plan views of variations of grooves and ribs of an Embodiment 11;

FIGS. 26A to 26D are cross-sectional views of variations of the grooves and ribs of Embodiment 11;

FIGS. 27A to 27E are plan views of grooves of an Embodiment 12;

FIGS. 28A to 28E are plan views of ribs of an Embodiment 13;

FIGS. 29A and 29B are plan views of grooves and ribs of an Embodiment 14; and

FIG. 30 is a plan view of grooves of an Embodiment 15.

### DESCRIPTION OF THE EMBODIMENTS

With reference to the drawings, preferred embodiments of the present invention will be illustrated hereinafter in detail. However, the dimensions, materials, shapes, and relative arrangements of the components described in these embodiments are not intended to limit the scope of this invention to them alone, unless otherwise specified. In addition, the materials, shapes, etc., of the components described once in the following description are the same as those in the initial description in the subsequent description, unless otherwise noted.

### Apparatus Configuration

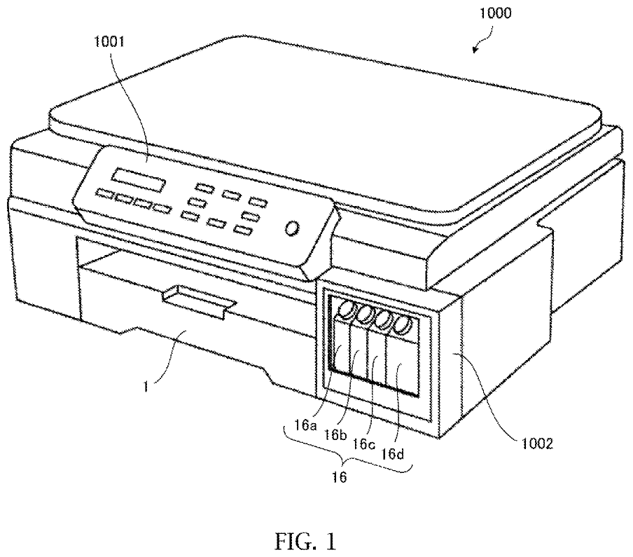

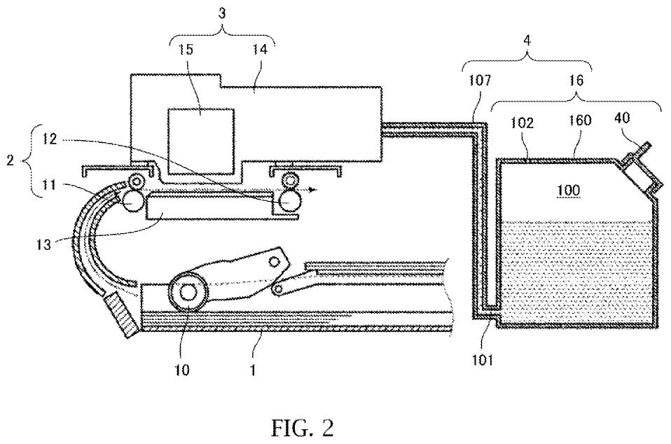

FIG. 1 is a perspective view of an ink jet recording apparatus of one embodiment of the present invention. FIG. 2 is a schematic side view showing an essential part of the ink jet recording apparatus of this embodiment. The present invention can, for example, be suitably used for an ink container bottle in which printing ink is stored and a system having a liquid tank to which the printing ink container bottle is connected.

An ink jet recording apparatus 1000 (hereinafter also referred to as “the recording apparatus”) has a first feed unit 1, a second feed unit 2, a recording unit 3, and a liquid supply unit 4. The first feed unit 1 has a feed roller 10 that separates one sheet of recording medium at a time from a stack of recording media and feeds the sheet to the second feed unit 2. The second feed unit 2 is provided downstream of the first feed unit 1 relative to the direction of transportation of the recording media, and has a transportation roller 11 that transports recording media that are fed from the feed roller 10 and a paper discharge roller 12. A platen 13 is provided between the transportation roller 11 and the paper discharge roller 12 to support from underneath the recording media transported from the second feed unit 2.

A recording unit 3 is provided opposite the platen 13 and includes a carriage 14 that reciprocates orthogonally to the direction in which the recording media is transported, and a recording head 15 mounted in the carriage 14 and having a plurality of rows of discharge ports each of which is comprised of a plurality of discharge ports. The recording head 15 discharges ink of different colors from the rows of discharge ports and records color images on a recording medium supported by the platen 13 by driving, based on recording data, energy generating elements provided therein to correspond to the discharge ports.

A liquid supply unit 4 includes a liquid tanks 16, such as translucent or transparent containers, and flexible supply tubes 107 connecting the liquid tanks 16 to the recording head 15. In this embodiment, ink of four colors (for example, cyan, magenta, yellow, and black) is used as the liquid, and four liquid tanks 16a to 16d, each containing ink of a color, as the liquid tanks 16. It should be noted that the number of ink colors is not limited to four. Moreover, the liquid is not limited to ink. Rather, it may be a recording liquid, fixing solution, resist, etc.

The liquid tank 16 includes a tank body 160 that includes therein a container chamber 100 for containing the liquid and a cap 40 that can be fitted on the tank body 160 to seal the container chamber 100. A supply port 101 connected to the supply tube 107 is provided at a lower part of the tank body 160, and an atmospheric communication port 102 that places the container chamber 100 in communication with the atmosphere is provided in the top surface of the tank body 160. When liquid is discharged from the recording head 15, the negative pressure in the recording head 15 builds up, causing the liquid contained in the container chamber 100 in the liquid tank 16 to be supplied from the supply port 101 to the recording head 15 via the supply tube 107. At this moment, the same amount of air as that of the liquid supplied to the recording head 15 flows into the container chamber 100 in the liquid tank 16 via the atmospheric communication port 102.

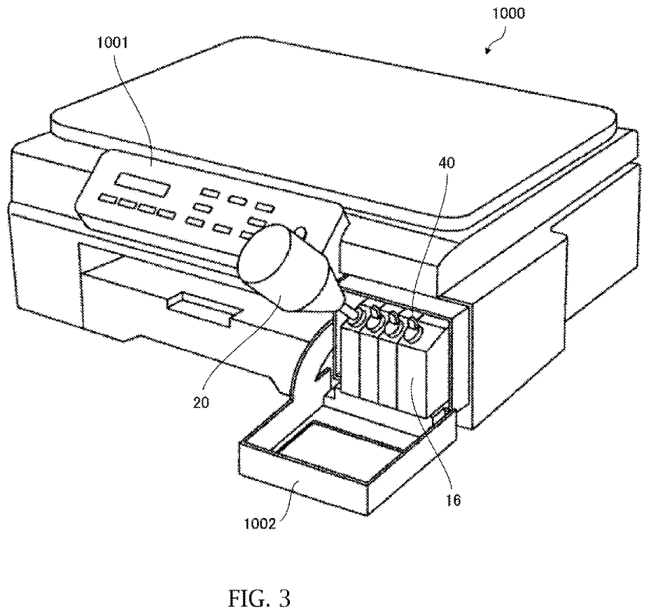

FIG. 3 shows a perspective view showing how liquid is refilled to the recording apparatus shown in FIG. 1. When a remaining ink-amount detection means (not shown) provided in the liquid tank 16 detects that the amount of liquid remaining in the container chamber 100 is less than a predetermined amount, a display unit 1001 of the recording apparatus 1000 shows an message prompting the user to refill the liquid tank 16. The user pulls down and open a tank cover 1002 provided at the front of the recording apparatus 1000 and removes the cap 40 attached to the liquid tank 16 to be refilled with liquid so as to expose a supplied portion or a liquid injection portion 18. Then, the liquid is refilled into the liquid tank 16 via the exposed liquid injection portion 18 using the ink container bottle 20 that contains the liquid to be refilled. It should be noted that multiple types of ink container bottles 20 are provided in advance (four types in this embodiment) according to the number of colors of liquid (ink) used. Each of the ink container bottles 20 shows color information of the liquid (ink) contained therein. The user selects the ink container bottle 20 that contains the liquid to be refilled from among the plurality of available ink container bottles 20, based on the information shown on the display unit 1001 and the color information also shown on the liquid tank 16.

### Bottle Structure

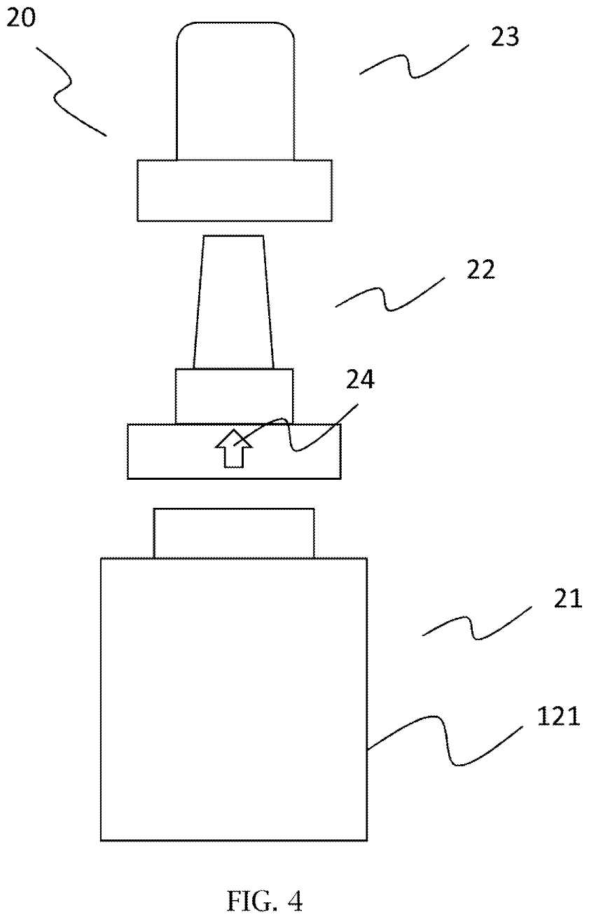

FIG. 4 is a component diagram of the ink container bottle 20, which serves as a liquid container for refilling the liquid to the liquid tank 16. The bottle includes a bottle body 21 serving as a main body for containing liquid, a nozzle body 22 connected with the bottle body 21, and a cap 23 fitted on the nozzle body 22. The nozzle body 22 serves as the outlet for ejecting the liquid contained in the bottle body 21 to the outside. The cap 23 shields the interior of the ink container bottle 20 from the exterior by being fitted on the nozzle body 22. The nozzle body 22 is detachably attached to the bottle body 21 and can be threadably connected to the bottle body 21. It should be noted that the nozzle body 22 may be integrally formed with the bottle body 21. In the case of integral forming, there are methods available, such as sandwiching a flexible component between the bottle body 21 and nozzle body 22 for sealing, or providing both the bottle body 21 and nozzle body 22 as resin components to be welded together. The cap 23 is a discrete component having a cylindrical shape. The cap 23 is detachably attached to the nozzle body 22. The cap 23 is detachably attached to the bottle body 21 via the nozzle body 22.

### Nozzle Structure

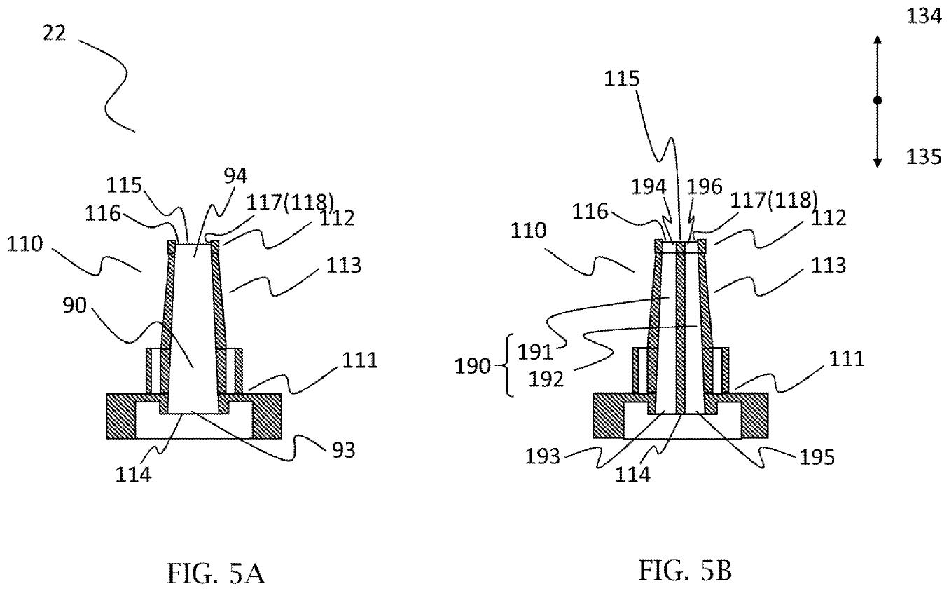

FIGS. 5A and 5B are cross-sectional views of the nozzle body 22. As shown in FIG. 5A, a nozzle 110 protrudes in a first direction 134 from the outer surface of a bottom wall 111 of the nozzle body 22. That is, with the nozzle body 22 attached to the bottle body 21, the nozzle 110 protrudes in the first direction 134 from the bottle body 21 via the nozzle body 22. The nozzle 110 may also protrude in a second direction 135 from the bottom wall 111 as well as in the first direction 134 from the bottom wall 111. In this case, the nozzle is provided to penetrate the bottom wall 111.

The nozzle 110 has a generally cylindrical shape. The nozzle 110 includes an outer peripheral surface 112 having a circumferential cross-section. An outer peripheral surface 113 constituting a part of the outer peripheral surface 112 has a tapered shape inclined from the bottom wall 111 in the first direction 134 to reduce the diameter of outer peripheral circle thereof. This shape allows smooth movement of the nozzle 110 as the nozzle is gradually inserted into the tank, its distal end away from the bottle body 21 first. However, the outer peripheral surface of the nozzle 110 may extend vertically from the bottom wall 111 to its top so that the outer peripheral circle thereof maintains the same diameter. Furthermore, in addition to a cylindrical shape, the nozzle may have a shape of a square pole.

The nozzle 110 includes a flow path 90 through which ink or gas passes. The flow path 90 penetrates the nozzle body 22 along the first direction 134. The flow path 90, extending along the first direction 134, is not limited to this configuration, but may also be curved. The cross-sectional shape of the flow path 90 may be circular or any other shape. With the nozzle body 22 attached to the bottle body 21, one end of the flow path 90 is in communication with the bottle body 21 via an opening 93. The other end of the flow path is in communication with the exterior of the nozzle body 22 via an opening 94 at the distal end of the nozzle. The opening 93 has a circular shape. The opening 93 may be formed in any other shape than a circular shape. Moreover, the opening 93 may be formed in any location other than a proximal surface 114 as long as the opening is formed in the proximal end of the nozzle 110. The opening 94 is formed in a top surface 115 that forms the end of the nozzle 110, which points in the first direction 134. The opening 94 has a circular shape. It should be noted that the opening 94 may be formed in any other shape than a circular shape.

As shown in FIG. 5B, the nozzle 110 may have two flow paths, a first flow path 191 and a second flow path 192, as the flow paths 190. The first flow path 191 and the second flow path 192 may have the same length or different lengths along the direction in which ink passes. The cross sections of the first flow path 191 and the second flow path 192 may have the same or different shapes or areas. Moreover, the number of multiple flow paths 190 may be greater than two. If a plurality of flow paths 190 are provided, each of the flow paths 190 may have the same or different lengths or shapes. If the nozzle 110 has two flow paths 190, the openings 193 and 195 are formed in the same plane on the proximal end thereof. However, they may also be formed in different planes. A first opening 194 and a second opening 196 are formed in the top surface 115 that forms the end of the nozzle 110 pointing in the first direction 134. However, the first opening 194 and the second opening 196 may be formed in any location other than the top surface 115 as long as these openings are formed in the top end of the nozzle 110. The first opening 194 and the second opening 196 have a circular shape. It should be noted that first opening 194 and the second opening 196 may have any shape other than a circular shape.

The top end of the nozzle 110 is a portion thereof formed, for example, by the top surface 115 and the outer peripheral surface 112 of the nozzle 110. The nozzle 110 also includes a recess portion 116 in the outer peripheral surface 112. The recess portion 116 is defined by the top surface 115 and an inner peripheral surface 118 (one of side surfaces) of an annular rib 117 that protrudes from an outer edge portion of the top surface 115 in the first direction 134. That is, the top surface 115 is recessed from the top of the nozzle 110 (the top of the annular rib 117). The inner peripheral surface 118 extends from the top surface 115 in the first direction 134 toward the outer edge of the top surface 115. In other words, the inner peripheral surface 118 extends in the first direction 134 while being sloped to increase the diameter of the recess portion 116. It should be noted that the inner peripheral surface 118 may extend along the first direction 134 without being sloped. It should be noted that the nozzle 110 may not includes the recess portion 116. In other words, the top end of the nozzle 110 may not be recessed.

### Ink Supply

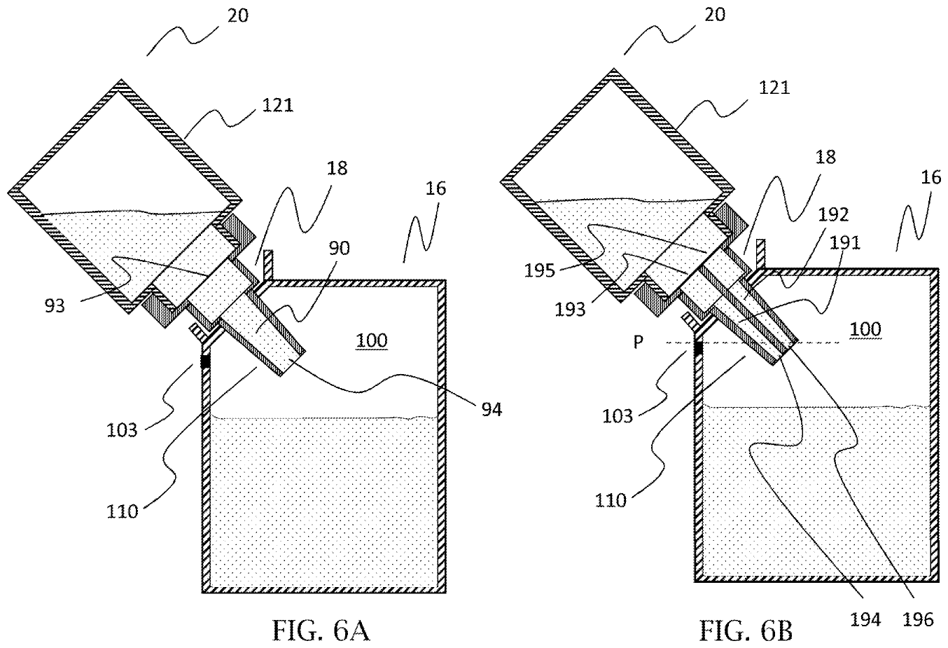

As shown in FIGS. 6A and 6B, the ink container bottle 20 is connected to the liquid tank 16 by inserting the nozzle 110 of the ink container bottle 20 into the liquid injection portion 18 of the liquid tank 16. The attitude of the ink container bottle 20 when the ink container bottle 20 is connected to the liquid tank 16 will be hereinafter also referred to as the connection attitude. When the nozzle 110 of the ink container bottle 20 is inserted into the liquid injection portion 18 of the liquid tank 16, by adjusting the attitude of the ink container bottle 20 so that a mark 24 (see FIG. 4) on the nozzle body 22 faces vertically upward, the orientation of the openings 94, 194, 196 can be defined when the openings 94, 194, 196 are located in the container chamber 100.

If two openings are provided as shown in FIG. 6B, one of the first and second openings 194 and 196 can be above the other when the first and second openings 194 and 196 are located in the container chamber 100. In this embodiment, the second opening 196 is positioned above the first opening 194 in the connection attitude of the ink container bottle 20. Once the ink container bottle 20 is connected to the liquid tank 16 with the opening 94 and the first and second openings 194 and 196 are located in the container chamber 100 of the liquid tank 16, the bottle body 21 and the container chamber 100 are in communication with each other via the flow path 90 or 190.

In the connection attitude of the bottle in FIG. 6A, for example, when the sidewall 121 of the bottle body 21 is pressed, the ink stored in the bottle body 21 passes into the flow path 90 via the opening 93. As the sidewall 121 of the bottle body 21 restores its original shape, air passes into the bottle body 21 via the opening 94. Note that the volume of ink that passes into the container chamber 100 from the bottle body 21 is approximately the same as the volume of air that passes into the bottle body 21 from the container chamber 100. In this way, the deformation of the bottle body 21 causes gas liquid exchange in the ink container bottle 20. As a result, ink is supplied from the ink container bottle 20 to the liquid tank 16.

In the connection attitude of the bottle in FIG. 6B, ink is supplied from the ink container bottle 20 to the liquid tank 16 in the so-called chicken feed method. That is, once the ink container bottle 20 is connected to the liquid tank 16 so that the first and second openings 194 and 196 are located in the container chamber 100 of the liquid tank 16, the bottle body 21 and the container chamber 100 are in communication with each other via the first flow path 191 and the second flow path 192. As a result, ink stored in the bottle body 21 passes into the first flow path 191 via the third opening 193 and then into the container chamber 100 via the first opening 194.

During the passage of ink, air enters the container chamber 100 via the atmospheric communication port 102 and flows into the bottle body 21 via the second flow path 192. Note that the volume of ink that passes into the container chamber 100 from the bottle body 21 is approximately the same as the volume of air that passes into the bottle body 21 from the container chamber 100. In this way, gas liquid exchange occurs. As a result of the flow of ink into the container chamber 100, the liquid level of the ink rises in the container chamber 100 to the same level as the opening 196 or reaches the same level as a mark 103, the passage of air is cut off between the container chamber 100 and the bottle body 21 via the second flow path 192. Consequently, the passage of ink from the bottle body 21 into the container chamber 100 stops.

In addition to the above-described chicken feed method, as shown in FIG. 6A, ink may be supplied to the container chamber 100 from the ink container bottle 20 by deforming the sidewall 121 of the bottle body 21 of the ink container bottle 20.

### Embodiment 1

As described above, when the top of the nozzle 110 contacts the ink after ink is supplied from the ink container bottle 20 to the container chamber 100, or when the nozzle 110 is detached from the liquid injection portion 18 after ink is supplied, the ink adhering to the container chamber 100 or the liquid injection portion 18 and the surrounding area thereof may adhere to the top of the nozzle. As a result, the ink may drip or trickle to the side surface of the nozzle 110 of the ink container bottle 20, thus soiling the user's hands or the surrounding area.

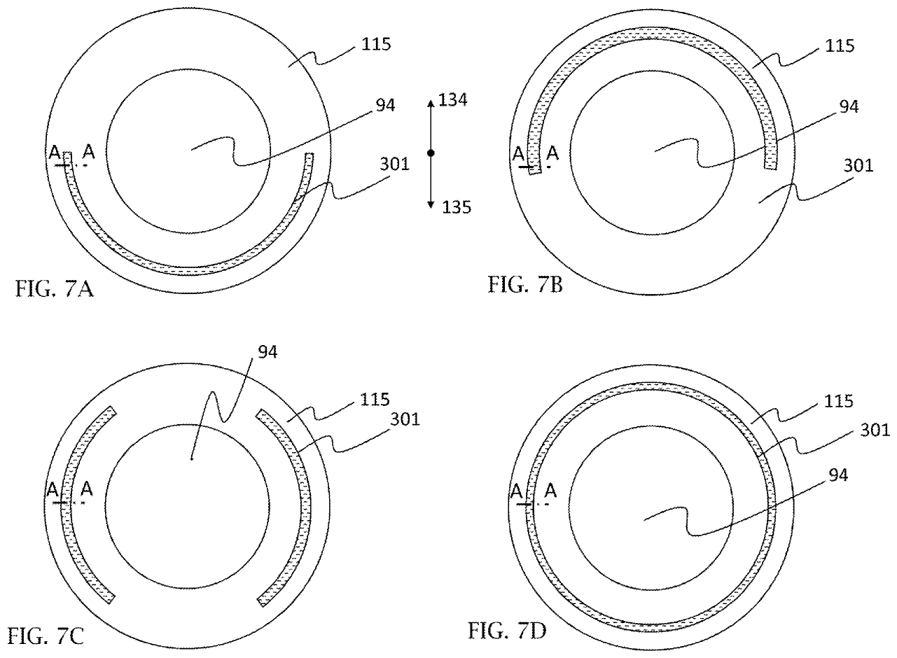

In contrast, according to this embodiment, the ink adhering to the top surface 115 of the nozzle 110 can be drawn into a groove 301 formed in the nozzle top surface 115 by the capillary force of the groove 301 to hold the ink in the groove 301. As shown in the plan views of FIGS. 7A to 7D, the groove 301 is formed in the nozzle top surface 115 between the opening 94 and the annular rib 117.

If the connection attitude of the bottle is defined by the mark 24, ink easily adheres to the side of the bottle located in the second direction 135 as the liquid level of the ink in the container chamber 100 of the liquid tank 16 rises. For this reason, as shown in FIG. 7A, the groove 301 may be formed on the side of the nozzle top surface 115 proximal to the second direction 135 in the connection attitude. Alternatively, as shown in FIG. 7B, the groove 301 may be formed on the side of the nozzle top surface 115 proximal to the first direction 134 in the connection attitude. While being supplied, ink comes into contact with the edge of the opening 94 on the side of the second direction 135. For that reason, ink is less likely to adhere to the side of the first direction 134. As a result, the amount of ink increases that can be drawn into the groove 301 after the nozzle 110 is detached. As shown in FIG. 7C, the groove 301 may also be formed on both sides of the opening 94. Ink is supplied to the container chamber 100 while being in contact with the edge of the opening 94 in the second direction 135. Therefore, by providing the groove 301 in an area less likely to come into contact with ink during the supply of ink to the container chamber 100, it is possible to prevent the groove 301 from affecting the supply of ink.

When the bottle is inserted, when ink is supplied, or when the bottle is removed, ink easily adheres to various parts of the nozzle depending, for example, on the shape of the bottle, the shape of the liquid tank, and the positional relationship between the bottle and the liquid tank. For example, there are cases where ink easily adheres to the lower side of the nozzle in the direction of gravity when the bottle is connected, as shown in FIG. 7A, ink easily adheres to the upper side of the nozzle in the direction of gravity as shown in FIG. 7B, ink easily adheres to both sides of the nozzle as shown in FIG. 7C, or any combination thereof. Therefore, ink may be effectively drawn into the groove by determining the position of the groove as shown in FIGS. 7A to 7C, depending on the part to which ink easily adheres.

Moreover, as shown in FIG. 7D, the groove 301 may also be formed to encircle the circumference of the opening 94 to retain the ink adhering to the nozzle top in the groove 301 regardless of the connection attitude of the bottle. The longer the circumference of the groove 301, the larger amount of ink can be retained therein.

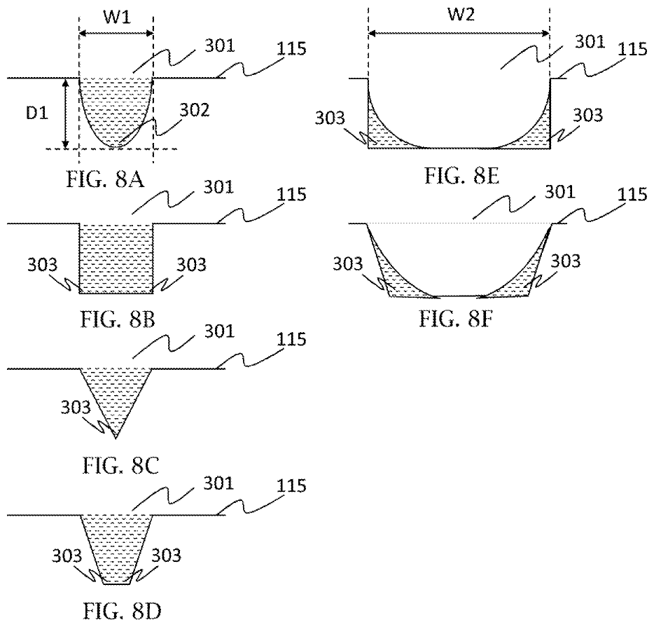

FIGS. 8A to 8F show examples of the cross-sectional shape of the groove 301 taken on lines A-A. Any cross-sectional shape of the groove 301 will suffice, such as a semi-elliptical or semicircular shape of FIG. 8A, as long as it has the shape of a fine groove capable of generating a capillary force. More preferably, the groove 301 may have an improved ability to retain ink if provided with one or more corners 303, such as in the rectangle shape of FIG. 8B, the triangular shape of FIG. 8C, and the trapezoidal shape of FIG. 8D. Additionally, the groove 301 may have a large opening width as those of FIGS. 8E and 8F as long as the groove is provided with corners 303 capable of generating a capillary force to draw in ink. For example, when forming grooves 301, especially narrow groove such as those in FIGS. 8A to 8D with shaping dies, the grooves 301 are formed to have a width W1 of approximately 0.1 mm to 2 mm. The width W2 of the grooves 301 of FIGS. 8E and 8F is formed to have approximately 2 mm or more to 5 mm. Additionally, the depth D1 is formed to range from approximately 0.05 mm to 5 mm. The method of forming the grooves 301 is not limited to the use of shaping dies; rather, the groove 301 may be formed by any other means. It should also be noted that the widths W1, W2 and the depth D1 of the grooves 301 are not limited to the foregoing.

### Embodiment 2

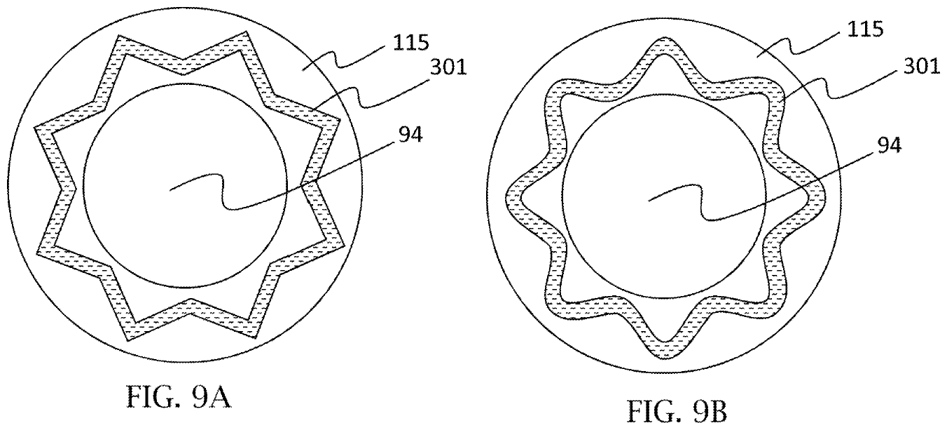

As shown in FIGS. 9A and 9B, the groove 301 may be bent. By being bent, the groove 301 has a longer circumference to be able to retain a larger amount of ink. The groove 301 may be bent linearly as shown in FIG. 9A, may be curved as shown in FIG. 9B, or may partially have a combination of linear and curved bends. The shape and width of the groove 301 may have a line or point symmetry, or may be different from location to location thereof.

### Embodiment 3

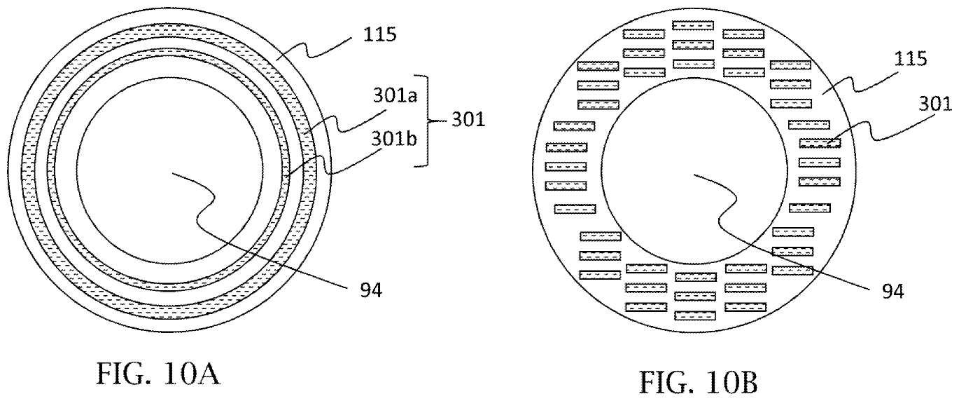

As shown in FIGS. 10A and 10B, a plurality of grooves 301 may be formed. As shown in FIG. 10A, a plurality of concentric grooves 301 may have different widths. Moreover, each of the grooves 301 may not be circular. In other words, the plurality of grooves 301 may not be concentric. Of the plurality of grooves 301, a second groove 301b may be located within a first groove 301a. The first groove 301a and the second groove 301b may be formed with breaks therein.

Furthermore, as shown in FIG. 10B, a plurality of (a large number of) grooves 301 may be discretely arranged in the nozzle top surface 115. To form a large number of grooves 301, they may be formed and arranged in a regular pattern as shown in FIG. 10B. Alternatively, the large number of grooves 301 may have irregular shapes with uneven intervals therebetween. By providing a plurality of grooves 301, a larger amount of ink may be retained. The large number of grooves 301 may have different orientations. The large number of grooves 301 may have different shapes, widths, and thicknesses. The large number of grooves 301 may be arranged so as not to overlap each other, or may partially overlap with each other as shown in FIG. 10B.

### Embodiment 4

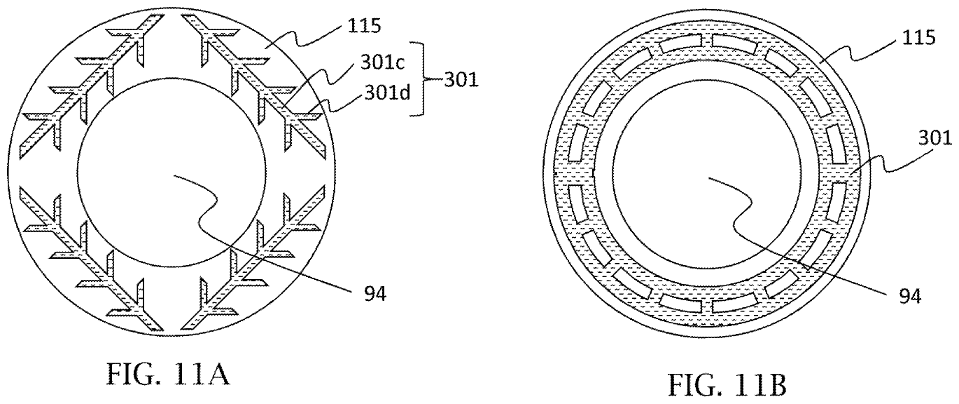

As shown in FIGS. 11A and 11B, grooves 301 may be formed to have branches. As shown in FIG. 11A, grooves 301d may branch off from main grooves 301c of the grooves 301. The branch grooves 301d may also have additional branches. Moreover, as shown in FIG. 11B, the grooves 301 may have branches that also join together. By having branches, the groove 301 may have a larger total volume so as to retain more ink therein.

### Embodiment 5

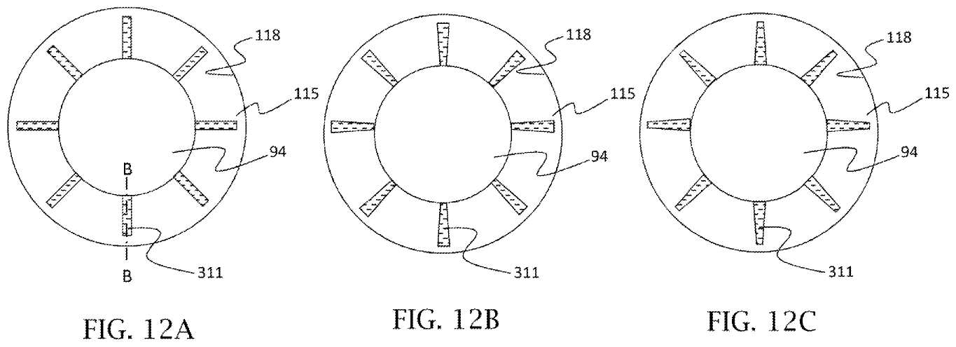

As shown in FIGS. 12A to 12C, grooves 311 may be formed so that portions of the grooves 311 may be in contact with the opening 94 of the nozzle top surface 115. The width of the grooves 311 may be constant as shown in FIG. 12A, or it may change as shown in FIGS. 12B and 12C. As shown in FIG. 12B, by increasing the width of the grooves 311 on the side of the inner peripheral surface 118, the ink adhering to the annular rib 117, i.e., the outer periphery of the nozzle top, is more likely to come into contact with the grooves 311, allowing a capillary force to draw and retain ink therein. That results in the suppression of ink trickling. By increasing the width of the grooves 311 toward the opening 94 as shown in FIG. 12C, a large amount of ink that has been drawn in the grooves 311 can be retained toward the opening 94. Dripping of ink can be suppressed as the ink retained in the grooves 311 may be allowed to trickle into the opening 94.

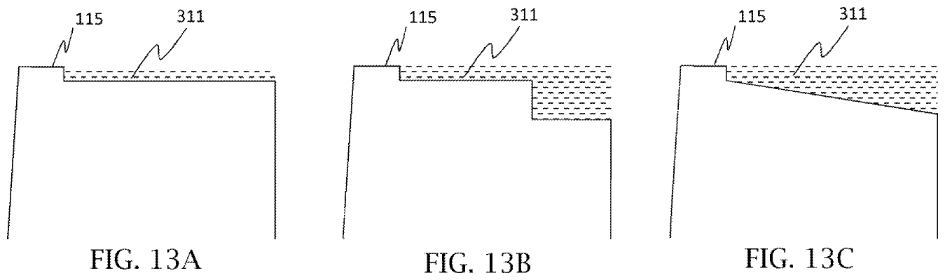

FIGS. 13A to 13C show the cross-section of a groove 311 taken on line B-B. As shown in FIG. 13A, the groove 311 may have a constant depth. As shown in FIGS. 13B and 13C, by increasing the depth of the groove 311 on the side of the opening 94, a large amount of ink that is drawn in the groove 311 may be retained near the opening 94. The depth of the groove may be varied in a stepwise or gradual manner (along an inclined surface), or both manners may be combined. Dripping of ink can be suppressed as the groove 311 is open to the opening 94 to allow the ink retained in the groove 311 to trickle into the opening 94.

### Embodiment 6

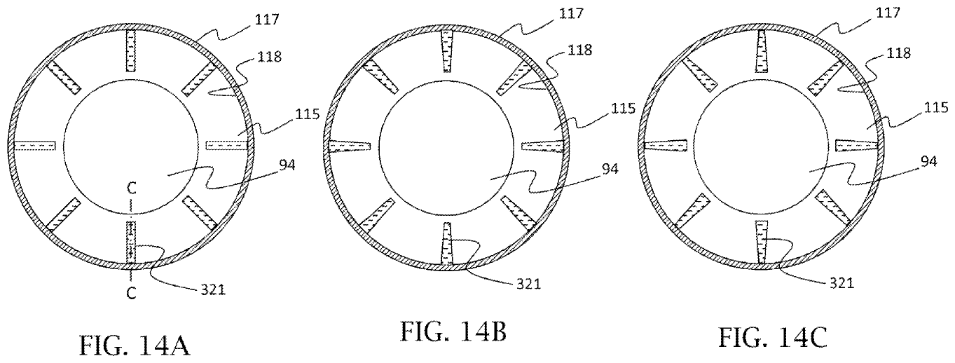

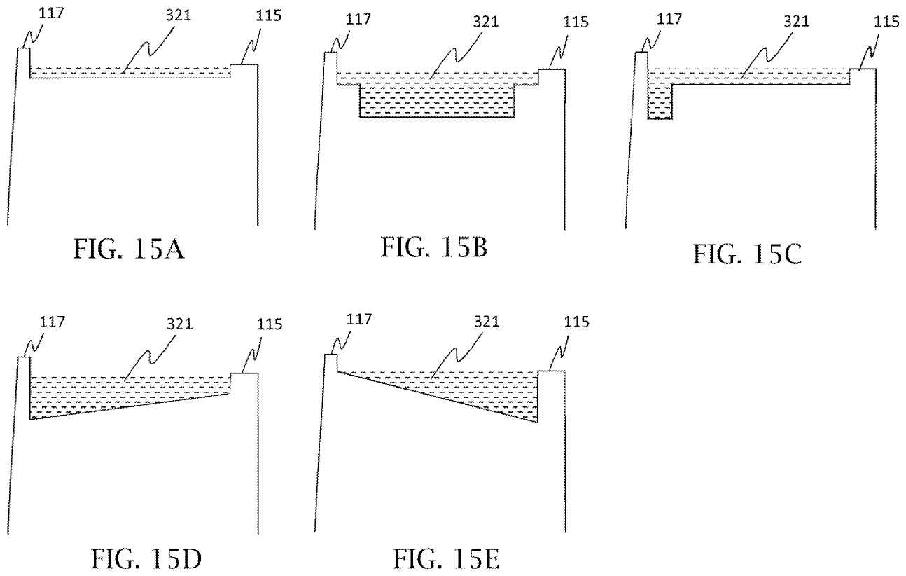

As shown in FIGS. 14A to 14C, grooves 321 may be formed with portions of the grooves 321 being partially in contact with the base of the inner peripheral surface 118 of the annular rib 117 located on the outermost periphery of the nozzle top surface 115. The width of the grooves 321 may be constant as shown in FIG. 14A, or it may change as shown in FIGS. 14B and 14C. As shown in FIG. 14B, by increasing the width of the grooves 321 on the side of the inner peripheral surface 118, the ink adhering to the annular rib 117 or the outer peripheral portion of the nozzle top can be retained in the grooves 321. That results in the suppression of ink trickling. By increasing the width of the grooves 321 toward the opening 94 as shown in FIG. 14C, a large amount of ink that has been drawn in the grooves 321 can be retained toward the opening 94. Dripping of ink can be suppressed as more ink can be retained within the nozzle top surface 115. FIGS. 15A to 15E show the cross-section of a groove 321 taken on line C-C. As shown in FIG. 15A, the groove 321 may have a constant depth. Furthermore, as shown in FIG. 15B, the groove may be formed with stepped depths. More ink can be retained by providing different levels in the depth of the groove 321. By increasing the depth of the grooves 321 on the side of the annular rib 117 as shown in FIGS. 15C and 15D, ink adhering to the annular rib 117 or the outer peripheral surface of the nozzle top can be retained in the grooves 321. That results in the suppression of ink trickling. As shown in FIG. 15E, by increasing the depth of the groove 321 on the side of the opening 94, a large amount of ink that has been drawn in the groove 321 may be retained near the opening 94. Dripping of ink can be suppressed as more ink can be retained within the nozzle top surface 115.

### Embodiment 7

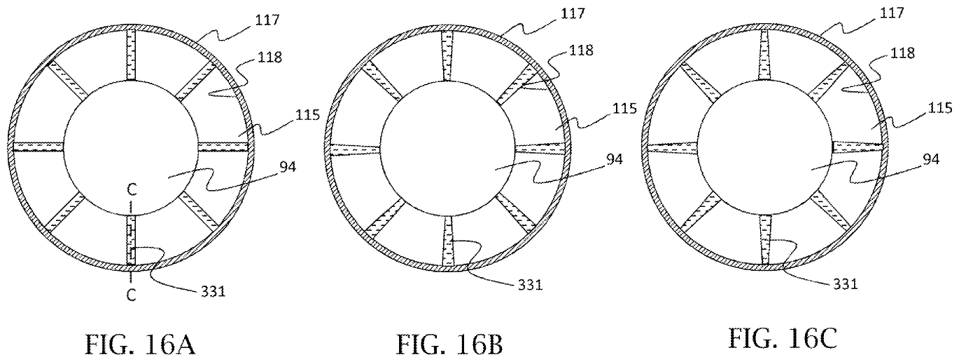

As shown in FIGS. 16A to 16C, grooves 331 may be formed with portions of the grooves 331 being partially in contact both with the base of the inner peripheral surface 118 of the annular rib 117 located on the outermost periphery of the nozzle top surface 115 and with the opening 94. The width of the grooves 331 may be constant as shown in FIG. 16A, or it may change as shown in FIGS. 16B and 16C.

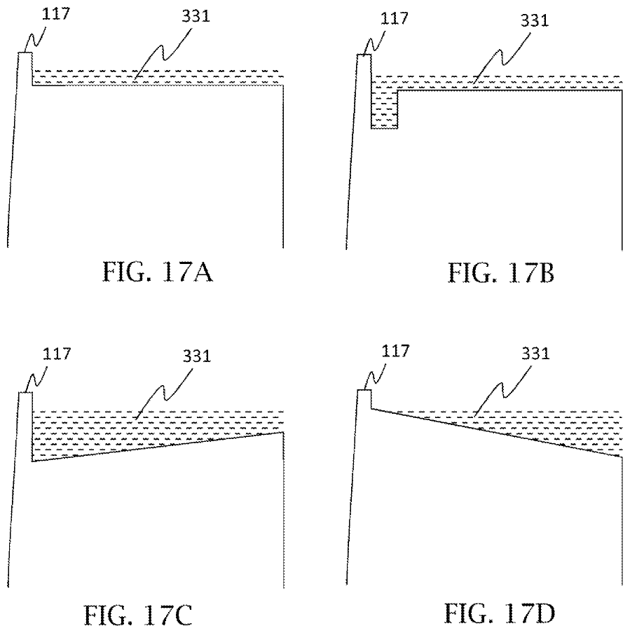

FIGS. 17A to 17D show the cross-sections of a groove 331 taken on line C-C. The depth of the groove 331 may be constant as shown in FIG. 17A, or it may change as shown in FIGS. 17B to 17D.

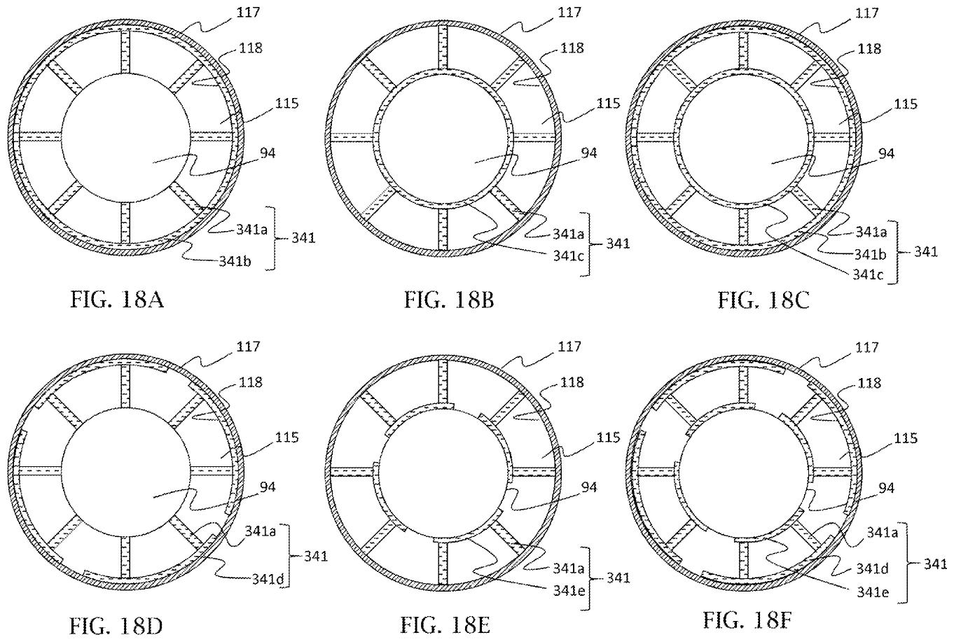

Furthermore, as shown in FIGS. 18A to 18F, the grooves 341 may be arranged as combinations of grooves 341a formed between the opening 94 and the base of the inner peripheral surface 118, a groove 341b formed on the base of the inner peripheral surface 118 of the annular rib 117, and a groove 341c formed along the circular outer periphery of the opening 94. The groove 341b and the groove 341c may be formed with breaks as grooves 341d and grooves 341e, respectively.

### Embodiment 8

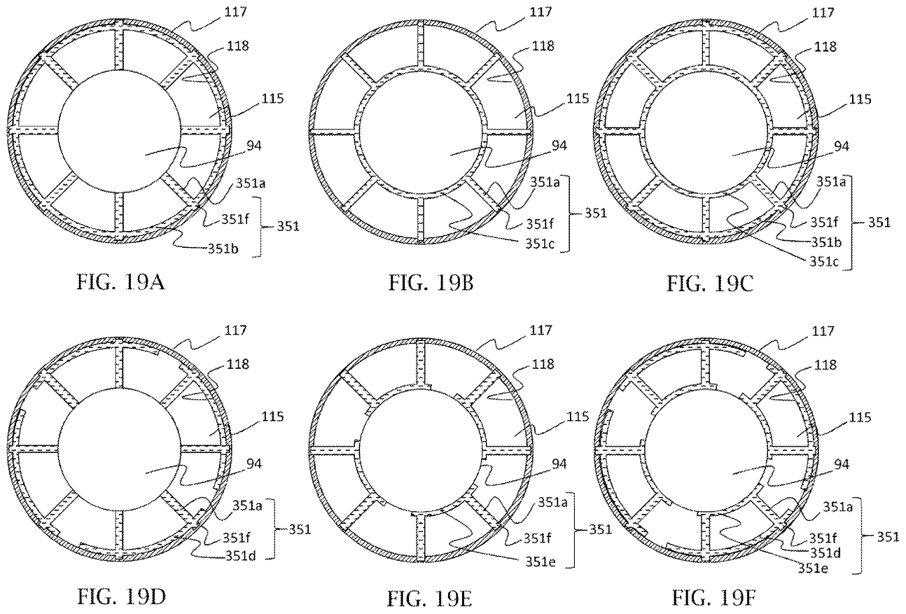

As shown in FIGS. 19A to 19F, grooves 351 may be formed as combinations of grooves 351a formed between the opening 94 and the base of the inner peripheral surface 118, a groove 351b formed on the base of the inner peripheral surface 118 of the annular rib 117, a groove 351c formed along the circumference of the opening 94, and grooves 351f formed in the inner peripheral surface 118 of the annular rib 117. The groove 351b and the groove 351c may be formed with breaks as grooves 351d and grooves 351e, respectively.

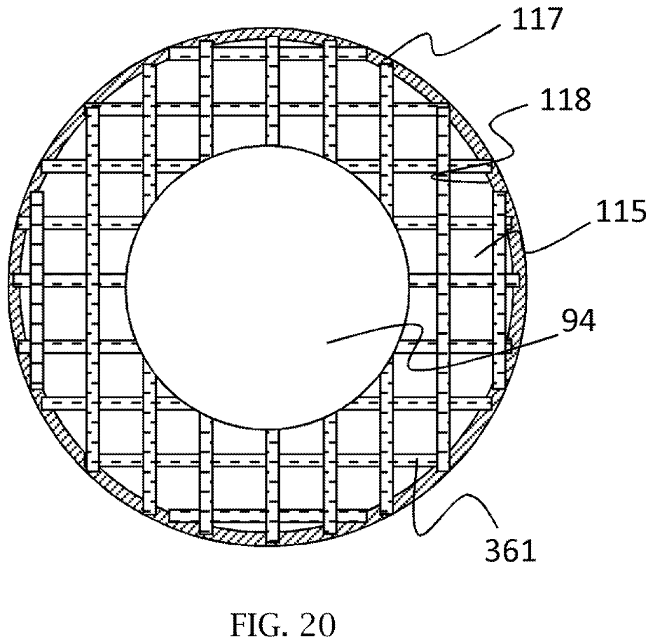

As shown in FIG. 20, grooves 361 may be formed as a mesh in the nozzle top surface 115. The mesh pattern is not limited to this. For example, the grooves 361 may be formed in an irregular mesh.

### Embodiment 9

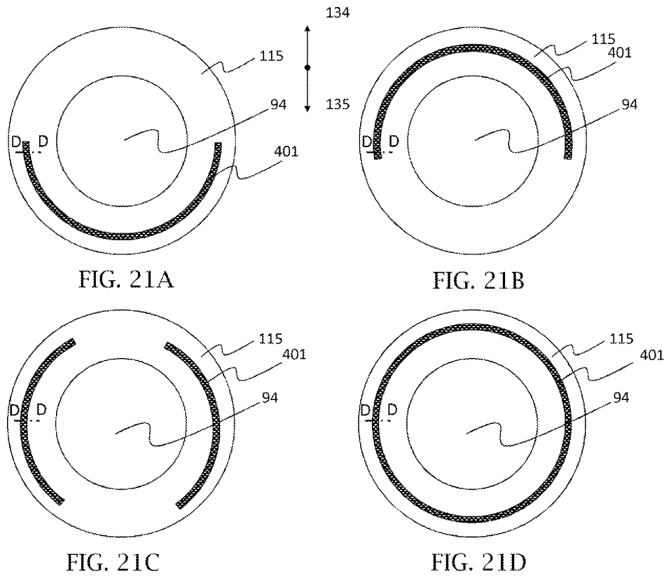

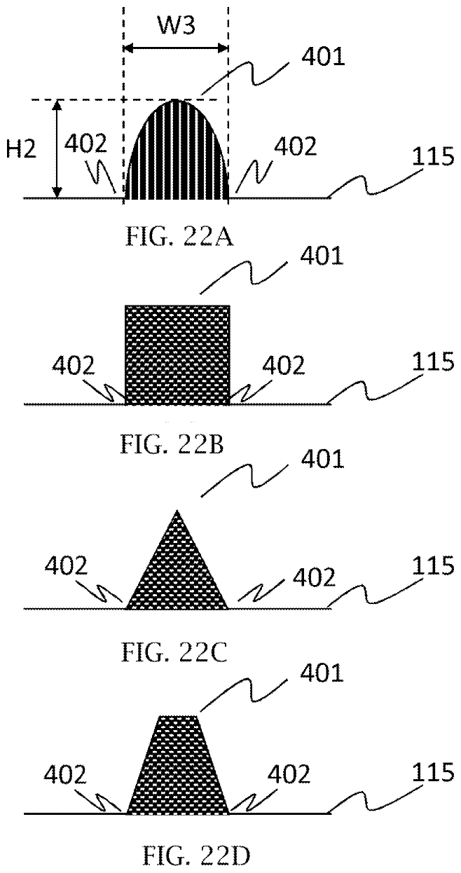

As shown in FIGS. 21A to 21D, a rib 401 may be formed on the top surface 115 of the nozzle 110. FIGS. 22A to 22D show the cross-sections of the ribs 401 taken on lines D-D. The ink adhering to the nozzle top is retained in corners 402 formed between the rib 401 formed on the nozzle top surface 115 and the nozzle top surface 115 by the capillary force of the corners 402.

As shown in FIG. 21A, the rib 401 may be formed on the side of the nozzle top surface 115 proximal to the second direction 135 in the connection attitude of the bottle. Alternatively, as shown in FIG. 21B, the rib 401 may be formed on the side of the nozzle top surface 115 proximal to the first direction 134 in the connection attitude of the bottle. While being supplied, ink comes into contact with the edge of the opening 94 on the side of the second direction 135. For that reason, ink is less likely to adhere to the side of the first direction 134. As a result, the amount of ink increases that can be drawn to the rib 401 after the nozzle 110 is detached. As shown in FIG. 21C, ribs 401 may be formed on both sides of the opening 94. Ink is supplied to the container chamber 100 while being in contact with the edge of the opening 94 in the second direction 135. Therefore, by providing the ribs 401 in areas less likely to come into contact with ink during the supply of ink to the container chamber 100, the ribs 401 can be prevented from affecting the ink supply operation. As shown in FIG. 21D, the rib 401 may also be formed to encircle the circumference of the opening 94 to retain on the rib 401 the ink adhering to the nozzle top regardless of the connection attitude of the bottle. The longer the circumference of the rib 401, the larger amount of ink can be retained therein.

FIGS. 22A to 22D show examples of the cross-sections of the ribs 401 taken on lines D-D. The cross-sectional shape of the ribs 401, as shown in FIG. 22A, may be semi-elliptical as long as corners 402 are formed between the nozzle top surface 115 and the base portion of he ribs 401. The corners 402, formed at the base portions of the ribs 401, have a capillary force to increase the ability to retain ink. The ribs 401 may also be formed in various shapes, such as a rectangle in FIG. 22B, a triangle in FIG. 22C, and a trapezoid in FIG. 22D. For example, when forming the rib 401 with shaping dies, the ribs are formed to have a width W3 of approximately 0.1 mm to 5 mm. Additionally, the height H2 of the ribs 401 ranges from approximately 0.05 mm to 5 mm. The method of forming the ribs 401 is not limited to the use of shaping dies; rather, the ribs 401 may be formed by any other means. It should also be noted that the width W3 and the height H2 of the ribs 401 are not limited to the foregoing. Embodiment 10

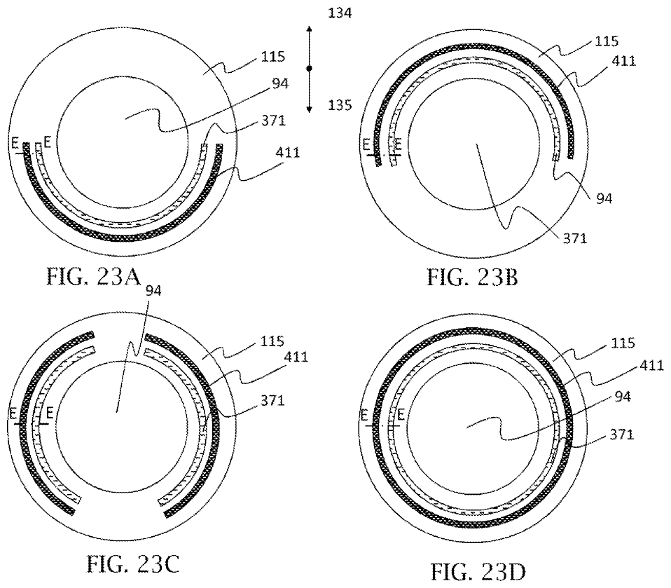

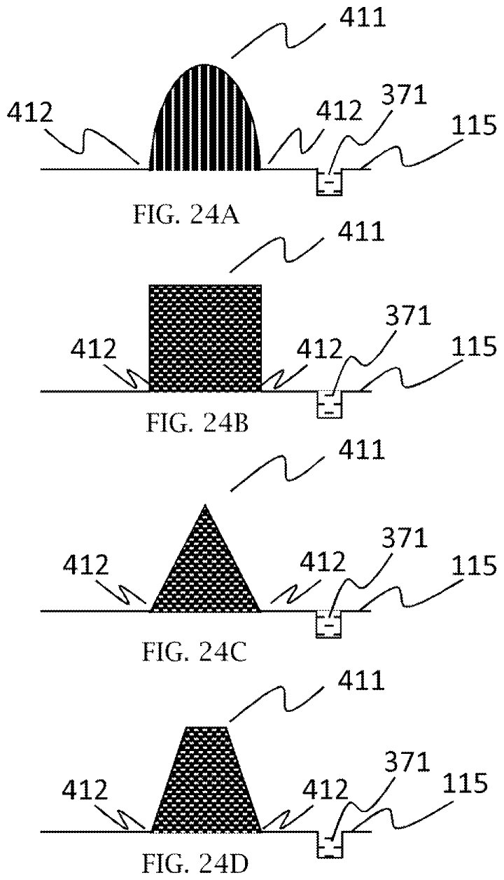

As shown in FIGS. 23A to 23D, both a rib 411 and a groove 371 may be formed on the top surface 115 of the nozzle 110. FIGS. 24A to 24D show the cross-sections of the grooves 371 and the ribs 411 taken on lines E-E. The ink adhering to the nozzle top is retained by the capillary force of the groove 371 formed in the nozzle top surface 115. Furthermore, the capillary force of the corners 412 formed between the rib 411 and the nozzle top surface 115 can retain ink in the corners 412. There is no particular limitation to the arrangement of the rib 411 and the grooves 371 as long as they are formed on or in the nozzle top surface 115.

### Embodiment 11

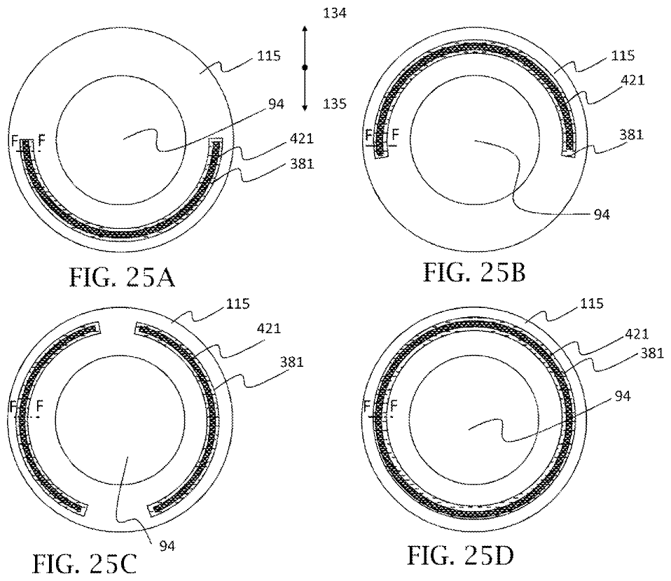

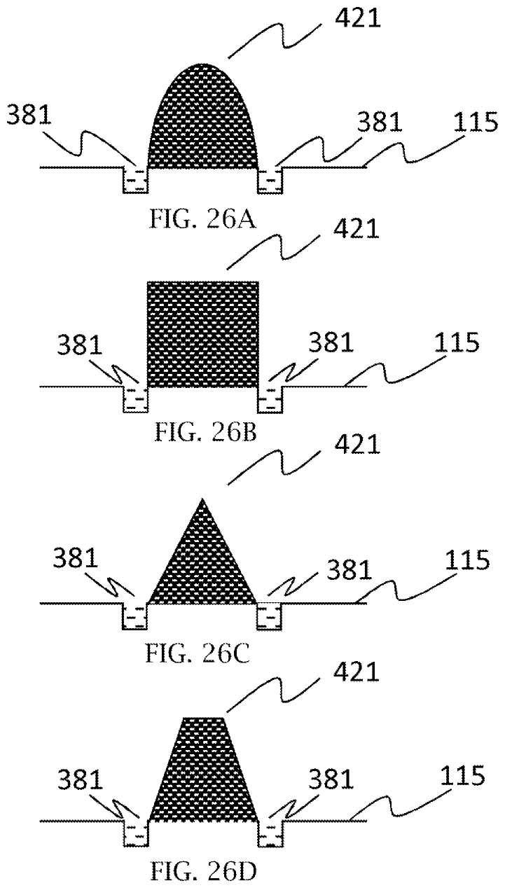

As shown in FIGS. 25A to 25D, both a rib 421 and a groove 381 may be formed on the top surface 115 of the nozzle 110. FIGS. 26A to 26D show the cross-sections of the grooves 381 and the ribs 421 taken on lines F-F. The ink adhering to the nozzle top is retained by the capillary force of the grooves 381 formed on the bases of the ribs 421 formed on the nozzle top surface 115. The grooves 381 may be provided on the outer peripheries of the ribs 421 or in the ribs 421. Moreover, the grooves 381 may traverse the ribs 421.

### Embodiment 12

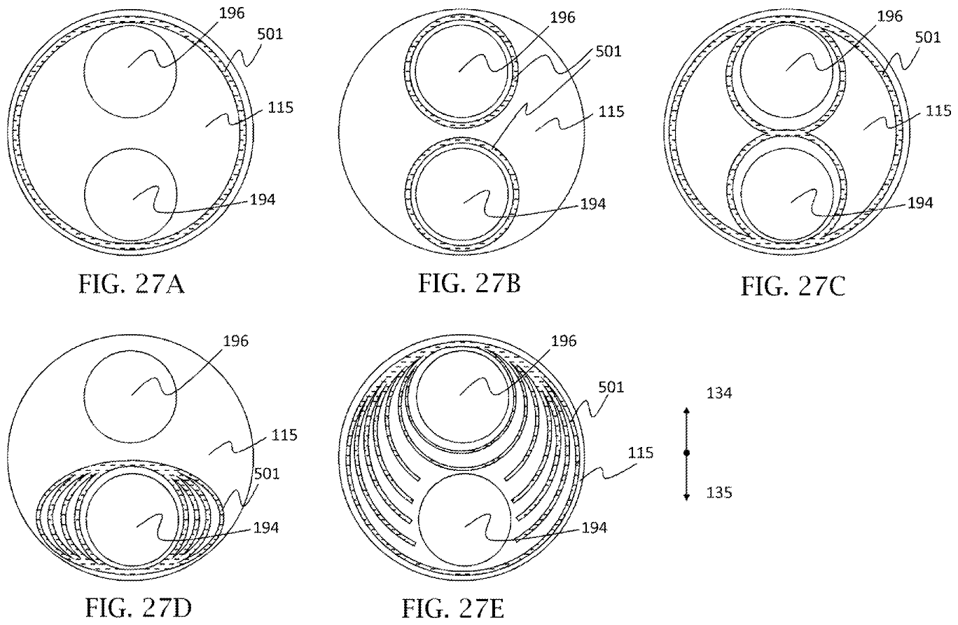

As shown in FIGS. 27A to 27E, a groove 501 may be formed on the top surface 115 of the nozzle 110. As shown in FIG. 27A, a groove 501 may be formed on the outer peripheries of the second opening 196 and the first opening 194. As shown in FIG. 27B, a groove 501 may be formed on the outer periphery of each of the second opening 196 and the first opening 194. As shown in FIG. 27C, a groove 501 formed on the outer periphery of the second opening 196, a groove 501 formed on the outer periphery of the first opening 194, and a groove 501 formed on the outermost peripheries of the second opening 196 and the first opening 194 may be used in combination. As shown in FIG. 27D, grooves 501 may be formed around the outer periphery of the first opening 194. To supply ink, when the mark 24 is used to define the connection attitude of the bottle, the first opening 194 is located on the lower side of the nozzle in the vertical direction. Therefore, a greater area of the location near the first opening 194 comes into contact with the liquid level of the ink that has risen due to the supply of ink. Accordingly, by providing grooves near the first opening 194, ink adhering to the nozzle top surface 115 can be drawn in and retained by the grooves 501. As shown in FIG. 27E, a large number of grooves 501 may be formed around the outer periphery of the second opening 196. Immediately after the supply of ink, a smaller area of the second opening 196 and its surrounding has ink adhering thereto than the first opening 194. Therefore, some grooves 501 can remain empty so that the ink that adheres to the nozzle top after the supply of ink may be retained in the grooves 501.

### Embodiment 13

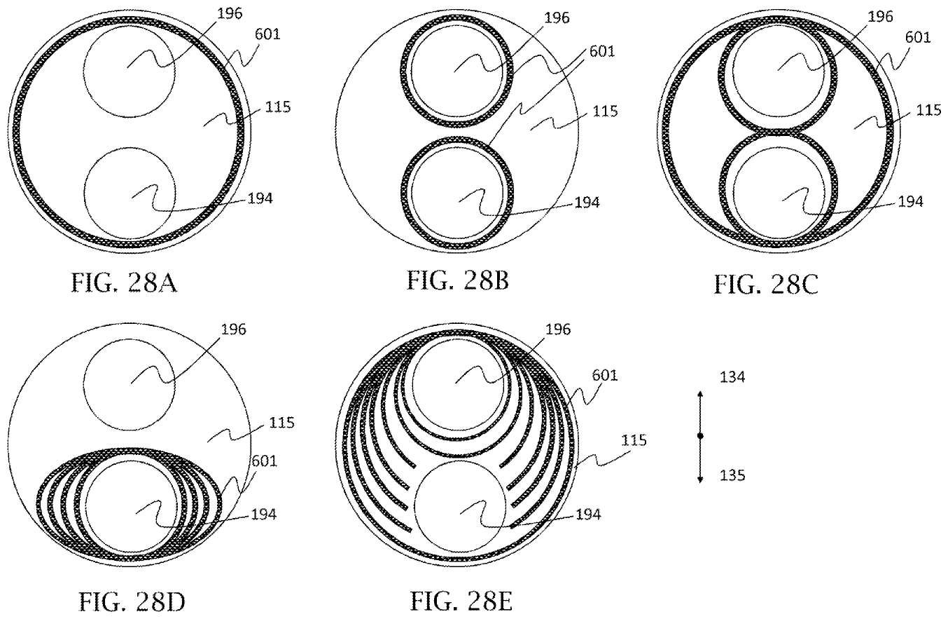

As shown in FIGS. 28A to 28E, a rib 601 may be formed on the top surface 115 of the nozzle 110. As shown in FIG. 28A, a rib 601 may be formed on the outer peripheries of the first opening 194 and the second opening 196. As shown in FIG. 28B, a rib 601 may be formed on the outer periphery of each of the first opening 194 and the second opening 196. As shown in FIG. 28C, a rib 601 formed on the outer periphery of the second opening 196, a rib 601 formed on the outer periphery of the first opening 194, and a rib 601 formed on the outermost peripheries of the second opening 196 and the first opening 194 may be used in combination. As shown in FIG. 28D, ribs 601 may be formed around the outer periphery of the first opening 194. To supply ink, when the mark 24 is used to define the connection attitude of the bottle, the first opening 194 is located on the lower side of the nozzle in the vertical direction. Therefore, a greater area of the location near the first opening 194 comes into contact with the liquid level of the ink that has risen due to the supply of ink. Accordingly, by providing ribs 601 near the first opening 194, ink adhering to the nozzle top surface 115 can be drawn in and retained by the ribs 601. As shown in FIG. 28E, a large number of ribs 601 may be formed around the outer periphery of the second opening 196. Immediately after the supply of ink, the area of the second opening 196 and the surrounding thereof in contact with the ink is smaller than that of the first opening 194. Therefore, some ribs 601 can remain empty so that the ink that adheres to the nozzle top after the supply of ink may be retained in the ribs 601.

### Embodiment 14

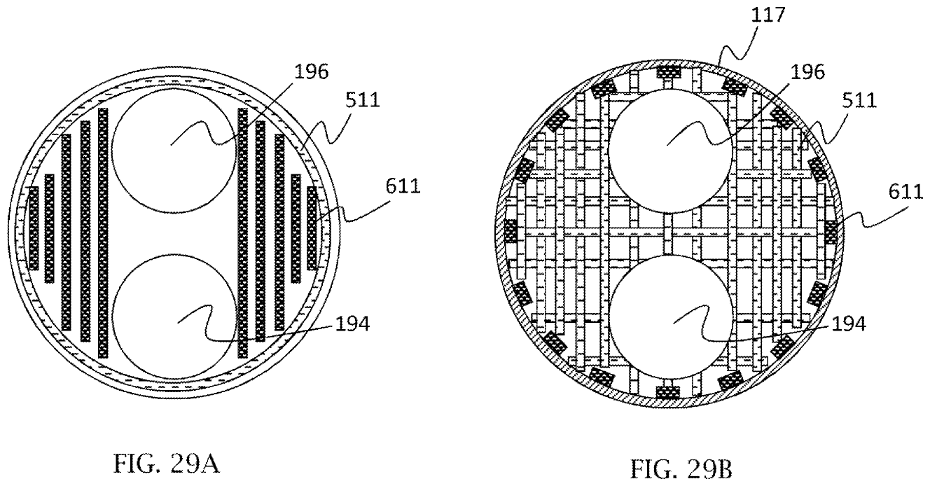

As shown in FIGS. 29A and 29B, grooves 511 and ribs 611 may be formed on the nozzle top surface 115. In this embodiment, the shape, arrangement, and thickness of the grooves 511, and the shape, arrangement, and thickness of the ribs 611 are not limited to these, but may be combined freely.

### Embodiment 15

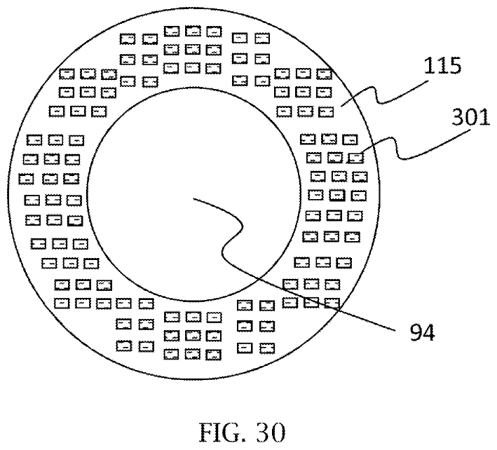

As shown in FIG. 30, a plurality of grooves 301 shorter than those of FIG. 10B may be formed. Such shapes may be referred to as “holes” rather than “grooves.” However, as these both have an improved ability to retain ink due to the grooves or holes being formed in the open surface, they may fall under the scope of the present invention. In other words, the term “groove” is not intended to set constraints on the ratio of the width to the length of the structures described herein. In such cases, the number, size, and arrangement of the grooves 301 are not limited. Additionally, in the configuration in which ribs are provided on the open surface, if the ribs are formed as a fine mesh, the portions surrounded by the ribs may take shapes similar to holes. Likewise, this case can also falls under the scope of the present invention.

The configurations of the foregoing embodiments can be freely combined with each other. For example, a nozzle may be manufactured that includes the shapes of the grooves of a plurality of embodiments. Furthermore, a nozzle may be manufactured that includes the shapes of the ribs of a plurality of embodiments. Moreover, if a nozzle includes both grooves and ribs, the nozzle may be manufactured that includes the grooves of a plurality of embodiments and the ribs of a plurality of embodiments. Furthermore, any of the shapes described in the embodiments in association with grooves may be applied to the shapes of ribs. Examples include structures of ribs with branches or mesh structures.

As described above, according to the present invention, the grooves and ribs provided in the port of a flow path in an ink container bottle through which liquid or gas passes serve as liquid draw-in portions that have a capillary force, so that the ink adhering to the opening and the surrounding area thereof is drawn to and retained in the grooves and the bases of the ribs. In this way, the ink on and around the opening of the ink container bottle detached after the supply of ink to the liquid tank, can be prevented from dripping or trickling to the side surface of the ink container bottle. Therefore, it is possible to reduce contamination of the opening of an ink container bottle for supplying ink to a liquid tank and the surrounding area thereof.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-062321, filed on Apr. 6, 2023, which is hereby incorporated by reference wherein in its entirety.

What is claimed is:

1. A bottle for use with a recording apparatus comprising a recording head for discharging liquid and a liquid tank for containing liquid supplied to the recording head, the bottle comprising:
a bottle body for containing the liquid; and
a liquid supply portion for connection to a supplied portion included in the liquid tank, the liquid supply portion including a flow path for passing the liquid from the bottle body to the liquid tank,
wherein the liquid supply portion includes, at a distal end thereof away from the bottle body, an outer peripheral surface for connection to an inner peripheral surface of the supplied portion and a port including an opening surrounded by the outer peripheral surface for supplying the liquid to the liquid tank from the flow path, and
wherein the port has a groove provided therein.

2. The bottle according to claim 1, wherein the groove is bent and formed around the opening.

3. The bottle according to claim 1, wherein the port includes a plurality of grooves provided around the opening.

4. The bottle according to claim 3, wherein the plurality of grooves are arranged so that a second groove is located within a first groove.

5. The bottle according to claim 3, wherein the plurality of grooves are arranged so as not to overlap each other.

6. The bottle according to claim 1, wherein the groove includes branches.

7. The bottle according to claim 1, wherein the groove is formed as a mesh.

8. The bottle according to claim 1, wherein a part of the groove is in contact with the opening of the liquid supply portion.

9. The bottle according to claim 1, wherein a part of the groove is formed along an outer periphery of the opening.

10. The bottle according to claim 1, wherein a part of the groove is in contact with the outer peripheral surface of the liquid supply portion.

11. The bottle according to claim 1, wherein the groove has a portion in contact with the outer peripheral surface of the liquid supply portion and a portion in contact with the opening.

12. The bottle according to claim 1, wherein the distal end of the liquid supply portion includes, within the outer peripheral surface, a recess in which the port is disposed.

13. The bottle according to claim 1, wherein the groove includes a cross-sectional shape capable of generating a capillary force.

14. The bottle according to claim 13, wherein the groove has a cross-sectional shape that includes corners.

15. The bottle according to claim 13, wherein the cross-sectional shape of the groove is semi-elliptical or semicircular.

16. The bottle according to claim 1, wherein the port further includes a rib provided thereon.

17. The bottle according to claim 1, wherein the groove is provided in a location to which the liquid easily adheres when the bottle is connected to the supplied portion.

18. The bottle according to claim 17, wherein the liquid supply portion includes a first flow path and a second flow path,
wherein the port includes a first opening for supplying the liquid that has passed the first flow path and a second opening for supplying the liquid that has passed the second flow path,
wherein the second opening is positioned above the first opening when the bottle is connected to the supplied portion, and
wherein the groove is provided on a side of the first opening.

19. A bottle for use with a recording apparatus comprising a recording head for discharging liquid and a liquid tank for containing liquid supplied to the recording head, the bottle comprising:
a bottle body for containing the liquid; and
a liquid supply portion for connection to a supplied portion included in the liquid tank, the liquid supply portion including a flow path for passing the liquid from the bottle body to the liquid tank,
wherein the liquid supply portion includes, at a distal end thereof away from the bottle body, an outer peripheral surface for connection to an inner peripheral surface of the supplied portion and a port including an opening surrounded by the outer peripheral surface for supplying the liquid to the liquid tank from the flow path, and
wherein the port has a rib provided therein.

20. The bottle according to claim 19, wherein the rib is bent and formed around the opening.

21. The bottle according to claim 19, wherein the port includes a plurality of ribs provided around the opening.

22. The bottle according to claim 19, wherein the rib includes branches.

23. The bottle according to claim 19, wherein the rib is formed as a mesh.

24. The bottle according to claim 19, wherein a part of the rib is in contact with the opening of the liquid supply portion.

25. The bottle according to claim 19, wherein a part of the rib is formed along an outer periphery of the opening.

26. The bottle according to claim 19, wherein a part of the rib is in contact with the outer peripheral surface of the liquid supply portion.

27. The bottle according to claim 19, wherein the rib includes a portion in contact with the outer peripheral surface of the liquid supply portion and a portion in contact with the opening.

28. The bottle according to claim 19, wherein the distal end of the liquid supply portion includes, within the outer peripheral surface, a recess in which the port is disposed.

29. The bottle according to claim 19, wherein the rib includes a cross-sectional shape capable of generating a capillary force.

30. The bottle according to claim 29, wherein the rib has a cross-sectional shape that includes corners.

31. The bottle according to claim 29, wherein the cross-sectional shape of the rib is semi-elliptical or semicircular.

32. The bottle according to claim 19, wherein the port further includes a groove provided therein.

33. The bottle according to claim 19, wherein the rib is provided in a location to which the liquid easily adheres when the bottle is connected to the supplied portion.

34. The bottle according to claim 33, wherein the liquid supply portion includes a first flow path and a second flow path,
wherein the port includes a first opening for supplying the liquid that has passed the first flow path and a second opening for supplying the liquid that has passed the second flow path,
wherein the second opening is positioned above the first opening when the bottle is connected to the supplied portion, and
wherein the rib is provided on a side of the first opening.
